(19) United States
(12) Patent Application Publication
(10) Pub. No.: US 2021/0297890 A1
(43) Pub. Date: Sep. 23, 2021

(54) SYSTEMS AND METHODS FOR DIFFERENTIATED USER INTERFACE GENERATION AND PRESENTATION BASED ON DIFFERENT COMMUNICATION CHANNELS

(71) Applicant: Verizon Patent and Licensing Inc., Arlington, VA (US)

(72) Inventors: Shoma Chakravarty, Chevy Chase, MD (US); Don Anton Roshan Dehipitiarachchi, Cumming, GA (US); Hermes Raymond Munian, Stroudsburg, PA (US)

(21) Appl. No.: 16/821,339

(22) Filed: Mar. 17, 2020

(51) Int. Cl. H04W 28/02; H04W 8/18

(52) U.S. Cl. CPC H04W 28/0263; H04W 92/08; H04W 8/183

(57) ABSTRACT

A system described herein may provide for decoupling user interfaces from backend input processing systems by receiving user input, identifying a journey state based on the received user input, identifying a set of templates based on the identified journey state, selecting a particular template from the set of templates based on a channel via which the user input was received (and/or one or more other factors), populating the template based on information associated with a User Equipment (“UE”) or user from which the input was received, and providing a journey page (e.g., based on the populated template) in response to the received user input.

### BACKGROUND

Service providers, such as wireless telecommunications network providers and/or other types of entities (e.g., companies, institutions, or other types of entities) may offer end-user support solutions (e.g., sales support, technical support, etc.). The support may be offered via purpose-built user interfaces that interact with purpose-built backends, which may be specifically designed for the type of support offered. For example, a user interface and backend for end users may be built by one development team that develops systems for end users, while a technical support user interface and backend may be built by another development team that develops the technical support system for technical support representatives.

### BRIEF DESCRIPTION OF THE DRAWINGS

FIG. 1 illustrates an example overview of one or more embodiments described herein, in which a Journey Optimization System (“JOS”) selects and/or generates one or more graphical user interfaces (“GUIs”) based on user type, received input, and/or other factors;

FIG. 2 illustrates an example data structure that may be used by a journey optimization system orchestration system, in accordance with some embodiments described herein;

FIG. 3 conceptually illustrates an example of a template that may be used to generate a journey page, in accordance with some embodiments described herein;

FIG. 4 illustrates example states of a journey, in accordance with some embodiments described herein;

FIG. 5 illustrates user input received via a UE, based on which one or more templates associated with a journey may be selected, in accordance with embodiments described herein;

FIG. 6 illustrates the selection of a particular template based on received input via a UE, in accordance with some embodiments described herein;

FIGS. 7-9 illustrate example generated journey pages, in accordance with some embodiments described herein;

FIG. 10 illustrates an example process for generating a journey page, in accordance with some embodiments;

FIG. 11 illustrates an example environment in which one or more embodiments, described herein, may be implemented; and

FIG. 12 illustrates example functional components of one or more devices, in accordance with one or more embodiments described herein.

### DETAILED DESCRIPTION OF THE PREFERRED EMBODIMENTS

The following detailed description refers to the accompanying drawings. The same reference numbers in different drawings may identify the same or similar elements.

Service providers may offer systems with which users may interact, including automated systems such as web-based graphical user interfaces (“GUIs”), GUIs presented in an application running on a device (sometimes referred to as an “app”), voice-based systems such as interactive voice response (“IVR”) systems, or the like. The systems are often purpose-built, in that a particular system may be geared toward one type of interaction (e.g., customer service interactions, technical support interactions, sales interactions, etc.). Communicating between different systems may be difficult or costly, in that different systems may have different communication pathways, messaging protocols, or may present other technical hurdles that prevent the systems from communicating.

As described herein, some embodiments may allow front-end (e.g., user-facing) components (e.g., GUIs, IVR systems, and/or other user interfaces) to be decoupled from back-end components (e.g., systems that process user input, modify templates or settings based on user input, provide information based on user input, reply to user input, etc.).

For example, the logic of what types of information to present to and/or request from a user may be de-coupled from the manner in which the information is presented to and/or requested from the user. For example, as described herein, a “journey” may refer to over logical flow of the types of information to present to and/or request from a user, and may have multiple states. A “journey state” may refer to a particular segment of a journey. A particular state may have specific triggering criteria, such as a particular type (or types) of information received (e.g., during a previous journey state) from a user, particular values received from a user, and/or other types of criteria discussed herein. A particular state may also have an associated set of actions, which may include the presentation of particular information, the validation of information provided by a user, and/or other types of actions discussed herein.

In accordance with some embodiments, the manner in which a particular journey state is presented to a user may vary based on factors such as a “channel” via which the journey is presented. As referred to herein, a “channel” may include a mode of communication, interaction, presentation, etc., such as a webpage, an “app,” a telephone call with a live operator, an IVR menu, etc. In some embodiments, one type of channel may be associated with customers (e.g., a first application which is associated with or available to customers), while another type of channel may be associated with technical support representatives or other users (e.g., a second application that is associated with technical support representatives). For example, as discussed herein, the same journey state (e.g., a journey state associated with purchasing a device from a set of available devices) may be associated with different modes of presentation based on a channel via which the journey state is associated. For example, if the journey state is associated with a customer accessing a retail web page, the presentation of the journey state may include the presentation of a web page with high-resolution images and verbose descriptions of product features. If, on the other hand, the same journey state is associated with a customer support representative accessing a customer support application, the presentation of the journey state may include the presentation of device names (e.g., without images), and summaries (e.g., as opposed to verbose descriptions) of device capabilities.

In some embodiments, the manner of presentation of a given journey state may be based on one or more other factors, in addition to, or in lieu of, a channel via which the journey state is presented. For example, as described herein, the presentation of a given journey state may be based on make or model of a device used to access the journey, a type or category of user accessing the journey, and/or other factors.

The separation of journey logic concerns (e.g., the types and/or values of information that are being requested or presented at a given journey state) and presentation logic concerns (e.g., the manner in which information is requested or presented) may provide for effective de-coupling of these concerns. In this manner, one single framework (e.g., in accordance with embodiments described herein) may be usable by organizations or entities that offer similar logical functionality for diverse types of channels, without requiring purpose-built UIs for each different combination of channel and journey state.

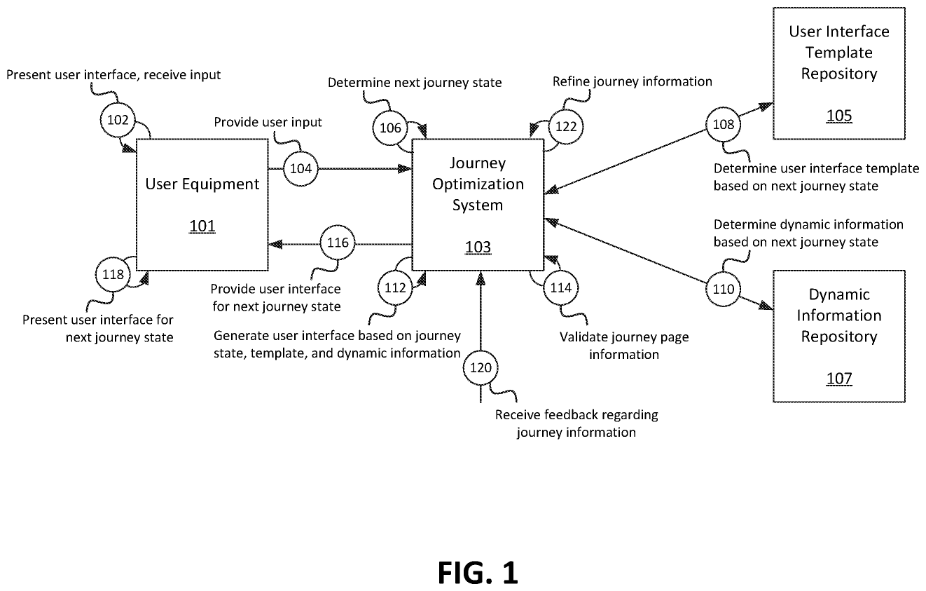

For example, as shown in FIG. 1, User Equipment (“UE”) 101, such a mobile telephone, a desktop computer, a laptop computer, etc., may present (at 102) a UI which is associated with a particular journey. As briefly discussed above, a journey may refer to a particular set of user interactions with a set of GUIs and/or other types of UIs, and the selection or presentation of such UIs for particular purpose. Interactions associated with a journey may include interactions with a graphical element in a GUI (e.g., a button, radio box, etc.), audible interactions (e.g., speaking into a microphone), gestures, and/or other suitable interactions.

UE 101 may have received the UI from JOS 103 and/or from some other source. For example, UE 101 may have received the UI as a web page from a web server that is communicatively coupled with JOS 103. As discussed with respect to this figure, UE 101 may communicate with JOS 103 (e.g., based on a Uniform Resource Locator (“URL”) or other information associated with the UI). However, in practice, some or all of the communications, shown in FIG. 1 as being between UE 101 and JOS 103, may include communications with one or more other devices or systems, such as a web server or other resource that provides or receives information from UE 101 (e.g., via a GUI, an audible system such as an IVR system, etc.).

As described below, a journey may have multiple states, including an initiation state and a completion state. An initiation state may occur, for example, as a result of an interaction with a UI that meets criteria associated with the initiation of the journey (e.g., providing a particular interaction on a particular element of a UI), and a completion state may be reached when interactions with a UI, and/or other factors, meet criteria associated with the completion of the journey. For example, a completion state may be a purchase of a device, a resolution of a technical support issue, and/or some other state that has been indicated or determined to be a completion of a given journey.

As discussed below, a UI may include interactive elements, such as text boxes, list boxes, buttons, or the like, which may be associated with one or more tags. These tags may indicate how to handle input received via the interactive element, and/or how to present further interactive elements or UIs. For example, tags may be used by JOS 103 to determine that a journey has been initiated, what a next state in the journey is, and/or that the journey has been completed. As described in more detail below, tags may be associated with various interactive elements when configuring a particular “journey page” for presentation via UE 101. As used herein, a “journey page” may present a UI for a particular state of a journey, and may include a GUI presented via UE 101, an audible menu presented by an IVR system, and/or some other suitable manner of presenting information and receiving user interactions. As also discussed below, one or more other factors may be used in configuring a journey page, such as identity or type of user, attributes of UE 101 (such as make or model), a channel associated with the journey, and/or other factors.

UE 101 may provide (at 104) the received user input and information associated with the interactive element via which the input was received. The identifying information associated with the interactive element may include, for example, an identifier of the interactive element (e.g., where each interactive element in the UI is associated with a unique identifier), a tag associated with the interactive element, a type of the interactive element (e.g., a text box, list box, etc.), and/or other information. In some embodiments, UE 101 may provide an indication of one or more elements for which input was not received. For example, assume that a UI includes multiple text boxes, of which one or more may have received no input while another text box received user input. In such an instance, UE 101 may indicate a lack of input in these other text boxes, as well as the input received via one or more text boxes.

In some embodiments, the user input (received at 104) may include additional information regarding UE 101, such as an identifier of UE 101 (e.g., a Mobile Directory Number (“MDN”), Internet Protocol (“IP”) address, International Mobile Subscriber Identity (“IMSI”), International Mobile Station Equipment Identity (“IMEI”), etc.), attributes of UE 101 (e.g., make and/or model of UE 101, screen size or screen resolution of UE 101, device type, etc.), location information associated with UE 101, information regarding a user associated with UE 101 (e.g., an identifier associated with the user, user type or group, etc.).

In some embodiments, the user input (received at 104) may include some or all of the above-mentioned information, and/or other information. In some embodiments, some or all of this information may have been received from UE 101 and/or some other device or system (e.g., a Home Subscriber Server (“HSS”) or Unified Data Management function (“UDM”) associated with a wireless network) that maintains or provides such information (e.g., via a Service Capability Exposure Function (“SCEF”) or a Network Exposure Function (“NEF”) associated with the wireless network). In some embodiments, JOS 103 may have received some or all of this information prior to the presentation (at 102) of the UI by UE 101, such as during a registration process of UE 101 with JOS 103 (not shown in FIG. 1). As discussed below, this additional information may be used in the determination of information, associated with the journey, to present to UE 101.

Once JOS 103 receives the user input from UE 101, JOS 103 may determine (at 106) the next state of the journey. As described below, the next state of the journey may be determined based on one or more factors, such as a set of user interactions (e.g., information or interactions received via one or more elements of the UI), identifiers or tags associated with UIs via which interactions were received (or not received, as similarly discussed above), an identifier of UE 101 (e.g., a MDN, IP address, IMSI, IMEI, etc.), an identifier of a user associated with UE 101, and/or other suitable information.

For example, the user input (received at 104) may be associated with a journey related to a user signing up for an email list. In such an example, the user input (received at 104) may include an email address input via a first interactive element of the UI, a name of the user input via a second interactive element of the UI, an identifier associated with UE 101 (e.g., as provided by the user and/or by UE 101), and/or other information. JOS 103 may determine, based on the received information (e.g., the email address and name input via the first and second interactive elements, and further based on the identifier associated with UE 101), that the next state is a completion state. The completion state may be associated with presenting (e.g., by UE 101) a journey page indicating a successful signup for the email list.

As a further example, assume JOS 103 receives a vocal input from UE 101 (e.g., via an IVR system). JOS 103 (or the IVR system and/or some other device or system) may determine that the vocal input includes words or phrases associated with the request to troubleshoot a particular device. Additionally, or alternatively, JOS 103 may determine that a menu selection via the IVR menu is associated with a request to troubleshoot the particular device. JOS 103 may determine, based on the determination that the input via the IVR menu is associated with a request to troubleshoot the particular device, that the next state of the journey is to provide troubleshooting tips for the particular device.

Based on the identified next state of the journey, JOS 103 may determine (at 108), generate, select, etc. a particular template to present information regarding the next journey state. In some embodiments, JOS 103 may select the template based on additional information (e.g., in addition to user interactions with a previous journey state). As mentioned above, the additional information may include, for example, an identifier of UE 101 (e.g., a MDN, IMSI, IMEI, etc.), an identifier of a user or subscriber associated with UE 101 (e.g., based on a user name or user account associated with the UI and/or otherwise associated with UE 101), attribute information associated with UE 101 (e.g., make and/or model, screen size, resolution, etc.), and/or other information. In accordance with some embodiments, different templates (e.g., as maintained or provided by UI template repository 105) may be associated with the same journey state, but with different channels (e.g., a mode of communication via which input was received from UE 101), users or user types (e.g., customers, customer service representatives, repair technicians, etc.), device types of UE 101 (e.g., mobile telephones, tablets, desktop computers, etc.), device attributes of UE 101 (e.g., different screen sizes, etc.), and/or other factors. As discussed herein, different templates may include different UI elements, different data fields (e.g., for static data or dynamic data, as discussed below), different arrangements of UI elements, etc.

In some embodiments, a template may be selected based on a user input (e.g., as received at 104). For example, assume a particular journey is associated with purchasing a device, where the user is able to compare multiple devices at the same time. In such an instance, JOS 103 may determine (at 106) that a next state, based on a user interaction (received at 104), is that available devices for purchase should be presented to the user. A user may select a plurality of devices to compare, but a template may be selected based on the number of devices selected for comparison. In other words, JOS 103 may select a first template, configured to compare three devices, based on a user selecting three devices to compare, whereas JOS 103 may select a second template, configured to display four or more devices, based on a user selecting four devices to compare.

As one example, JOS 103 may select the template based on information regarding attributes of UE 101. For example, given the same next state of the journey, JOS 103 may select a first template if UE 101 is a high-resolution or high-screen-sized device (e.g., a tablet computer, a mobile telephone with a screen resolution or size exceeding a threshold resolution or size, etc.), and may select a second template if UE 101 is a low-resolution or low-screen-sized device (e.g., a device with a screen resolution or size below the threshold resolution or size). In such an instance, the first and second templates may be differently configured to present information on devices having different screen resolutions or sizes (e.g., the first template may utilize more screen space, provide higher resolution images, increased font size, etc., compared to the second template).

As a second example of selection based on UE attribute information, assume that an identified journey state includes a request for location information of UE 101. As one example, assume that UE 101 includes functionality to determine its own location (e.g., using Global Positioning System (“GPS”) functionality). In such an instance, JOS 103 may select a template which includes an interactive element which provides an opportunity to confirm the location information received from UE 101.

As another example, assume that UE 101 does not have location determination functionality. In such an example, JOS 103 may select a template with an interactive element to request user input to indicate the location information. In this manner, a device with location determination capability may automatically acquire location information, and thus may utilize a template to confirm received location information, while a device without location determination capability may request a user input that indicates the location.

As a further example of template selection based on UE 101 information, a template may be selected based on the model information associated with UE 101. For example, if a next journey state is associated with the presentation of a set of devices for sale, and UE 101 matches a particular one of the presented devices, the selected template may include more information regarding the other devices than the same type of device of UE 101. In other words, the template, with less information about the device matching the type of UE 101, may be selected because a user associated with UE 101 may be knowledgeable about the device.

As another example, given the same journey state (i.e., presenting information associated with devices for purchase), assume UE 101 is a device associated with a first manufacturer, and the set of available devices include a device associated with a different second manufacturer. In such an instance, a selected template may compare the features of the first and second manufacturers (e.g., warranty information associated with the different manufacturers, locations of repair or retail outlets associated with the different manufacturers, etc.). Similarly, if the presented device is similar to the device type of UE 101 (e.g., both devices are mobile devices), JOS 103 may select a template which compares the two devices (e.g., provide a comparison between the device of UE 101 and the presented device). In contrast, if UE 101 is a desktop computer and the journey is for the purchase of a mobile device, the selected template may not compare UE 101 and the presented device.

In some embodiments, JOS 103 may select the template based on information regarding a user associated with the journey and/or with UE 101. As briefly discussed above, a distinction between two different user types may be referred to as a channel. For example, an experienced user (such as a sales agent) may be in a different channel from an inexperienced user (such as a customer), despite being in the same journey. In other words, despite trying to accomplish the same task (e.g., a transaction to sell a device), the information presented may be different. For example, assume the journey provides for the display and selection of a device for purchase. If JOS 103 receives information indicating that the user associated with UE 101 is experienced (e.g., a sales agent providing assistance for purchase, etc.), the journey may be placed in a first channel. In contrast, if JOS 103 receives information indicating that the user associated with UE 101 is inexperienced (e.g., a customer), the journey may be placed in a second channel. Templates selected for journeys in the first channel may present less information than journeys selected in the second channel because an experienced user may need less information to continue through the journey. JOS 103 may select a template presenting less information (e.g., display a model number and purchase price associated with a device, etc.) when in the first channel, and may select a template presenting more information (e.g., a template to display a model name, model number, picture, and/or purchase price associated with a device, etc.) when in the second channel.

JOS 103 may determine (at 110) dynamic information based on the identified next state of the journey (e.g., determined at 106). JOS 103 may query dynamic information repository (“DIR”) 107 using received inputs and/or determined next journey state to receive dynamic information for presentation via UE 101 (e.g., information displayed in an arrangement as configured by a template received at 108). Dynamic information may include, for example, retrieved information regarding a user associated with UE 101, information regarding the journey (e.g., a progress tracker), information requested by the user associated with UE 101 (e.g., as determined by the received next journey state, at 106), and/or other information. Assume, for example, UE 101 is a mobile device associated with a wireless service plan or subscription. JOS 103 may receive, based on an identifier associated with UE 101, subscriber information associated with UE 101 from DIR 107. In such an instance, DIR 107 may provide information such as an identifier associated with the subscriber, a service commencement date, eligibility for an upgrade, most recent troubleshooting experience, and/or other information. As a further example, assume the journey flow is providing for a purchase of a cellular mobile device. JOS 103 may receive dynamic information, in this particular journey, from DIR 107 such as offers on discounted prices available for the selected cellular mobile device, similar devices, information regarding the selected cellular mobile device (such as price, technical specifications, etc.), and/or other information.

Once information is received, JOS 103 may generate (at 112) a user interface associated with the next journey state, based on the journey state information, template information, and/or dynamic information. As discussed herein, this user interface will be referred to as a “journey page,” which may include one or more graphical elements. In practice, similar concepts may apply to audible systems, such as IVR systems. In some embodiments, generating a journey page may include placing dynamic information into respective UI elements. JOS 103 may generate and assign a unique identifier associated with the journey page and store the identifier and/or corresponding information in a repository. This may allow diagnostic information regarding a particular journey (e.g., in an instance that a validation fails and/or some other error occurs), may provide analytic details regarding a particular user journey (e.g., may be used to analyze trends associated with a journey), and/or may allow the information to be for other purposes.

In some embodiments, JOS 103 may validate (at 114) the journey page information, including the dynamic information (e.g., received at 110) and template (e.g., received at 108). Validation may occur, for example, by determining that any mandatory elements (e.g., information required in the received template) is has been provided by DIR 107. For example, if a template specifies that a name of the user associated with UE 101 should be included in the generated journey page (e.g., if the template includes a dynamic field for the user's name), JOS 103 may validate that the information is has been provided by DIR 107.

In some embodiments, machine learning techniques may be utilized to validate the generated page. Machine learning techniques may utilize feedback to enhance the information provided to JOS 103. For example, JOS 103 may maintain and/or refine predictive models associated with generated pages (e.g., to strengthen or weaken a correlation between a given journey page or template and the received journey information). Predictive models may include, for example, information regarding previously generated journey pages (e.g., pages generated for one or more previous journeys). Feedback may be used to modify one or more predictive models. For example, feedback indicating a correct journey page based on the same or similar information may strengthen or increase the association of the journey page with the criteria or parameters used to generate the journey page, whereas feedback indicating the journey page was incorrect based on the same or similar journey information may weaken or decrease this association. As described below, different feedback may modify the score differently (e.g., higher confidence feedback may impact a score more than lower confidence feedback).

In some embodiments, if JOS 103 is unable to validate a generated page or information used to generate the journey page, JOS 103 may attempt to resolve any validation issues. For example, JOS 103 may select a different template, request additional or different information from UE 101, and/or determine a different next journey state based on which to generate a journey page (e.g., a journey state that does not include or require the information that was not able to be validated).

Once the page is configured, JOS 103 may provide (at 116) the generated user interface associated with the next journey state (e.g., the journey page) to UE 101 for presentation. For example, the journey page may be provided as a web page, presented audibly via an IVR menu, “streamed” to UE 101, etc. Once received, UE 101 may present (at 118) the journey page (e.g., visibly, audibly, etc.). In this manner, some or all of the operations described above may be iteratively repeated, in order to receive further inputs via the presented journey page, and potentially identify subsequent journey states and associated journey pages.

JOS 103 may receive (at 120) feedback regarding the generated journey page. As mentioned above, in some embodiments, each generated page may be associated with a unique identifier, which may be used for feedback purposes. Feedback may be provided by UE 101, a user associated with UE 101, a user associated with JOS 103, and/or from other sources, and may be associated with each journey page, based on the generated identifier.

As mentioned above, in some embodiments, machine learning techniques may be used to refine or enhance the factors based on which a journey page may be generated. For example, JOS 103 may rely on feedback to enhance the information presented and/or the arrangement (e.g., according to a template) of information on a page, and enhance or refine the process of generating pages in the future based on the provided feedback, the confidence associated with the feedback, and/or other factors. When receiving feedback affirming the generation of a particular journey page, JOS 103 may strengthen predictive models associated with that selection. In other words, given the same or similar journey information (e.g., user interactions, UE attribute information, user attributes, etc.), JOS 103 would be more likely to generate the same journey page. If a user provides feedback rejecting the generated journey page (e.g., an explicit indication that the generation was not satisfactory, such as a response to a prompt asking if the generation was satisfactory or accurate, or an action based on which feedback may be inferred, such as modifying the generation within a threshold period of time), JOS 103 may be less likely to generate the same journey page given the same and/or similar journey information.

In some embodiments, a user may provide feedback affirming the generation of a particular page by providing explicit affirmative feedback, such as an affirmative answer when prompted whether the page generation was accurate or satisfactory. For example, an affirmative answer may be provided by a user via the presentation of a survey (e.g., a GUI querying the user regarding the journey experience, follow-up communication regarding the experience etc.).

In some embodiments, the feedback may include one or more actions through which feedback may be inferred, such as the user proceeding to use and/or not changing the selected page within a threshold period of time (e.g., indicating that the user was satisfied with the journey page generation and therefore did not modify the generated journey page). Assume, for example, a user associated with a particular journey exceeds a threshold time (e.g., one hour, fifteen minutes, etc.) to reach a completion state. In such an example, JOS 103 may determine that the journey was not successfully completed, and may modify the selection of one or more pages that were presented as part of the journey.

As a further example, if a customer initiates a particular journey, to purchase a device, via a first channel on a tablet computer, and further initiates a second channel via a telephone call to a customer support service without reaching a completion state in the first channel, JOS 103 may infer negative feedback regarding the first experience (e.g., JOS 103 may determine that a generated journey page associated with the first channel was incorrect). As discussed above, a customer support agent associated with the second channel may further receive information regarding the first channel, such as generated journey pages, user information, UE 101 information, etc.

In some embodiments, a user associated with JOS 103, such as a developer, may indicate feedback. For example, a developer, may arrange the received dynamic information (e.g., determined at 110) differently than indicated by the received template information (e.g., determined at 108). This modification may indicate that the developer-configured arrangement is more suitable than the template (e.g., the user-selected arrangement better matches the journey state and/or more one factors utilized to select a template). Modified pages may be provided to UE 101 for display (e.g., rather than providing the page generated by JOS 103, JOS 103 may provide the developer-configured page). In such embodiments, where a developer modifies a page, JOS 103 may store information regarding the developer-generated page to provide user-reinforced feedback. User-reinforced feedback may be used to enhance future page generation with a high degree of confidence. Different levels of confidence may indicate, for example, the degree to which a predictive model is modified. Feedback with a relatively high degree of confidence, for example, may impact a predictive model more heavily than feedback with relatively a low degree of confidence. For example, user-reinforced feedback may impact a predictive model more than inferred feedback.

In some embodiments, different types of feedback may be used to refine different aspects of template selection and/or journey state determination. For example, an indication that a next journey state does not follow a logical order may be utilized to improve the determination of the next journey state. Similarly, feedback indicating that the template did not present information in an understandable manner may be utilized to improve the determination of template information, while feedback indicating that the presented information was not useful may be utilized to improve received dynamic information.

As shown in FIG. 1, JOS 103 may refine (at 122) one or more predictive models that were used to generate the particular journey page. As described above, predictive models may be utilized to determine the selection of a particular template, the determination of a journey state, and/or the dynamic information presented via UE 101. For example, JOS 103 may determine whether the generation of a particular journey page was accurate or otherwise appropriate for the input (received at 104). As a further example, JOS 103 may determine whether the selected template (e.g., determined at 108) accurately presents necessary information. JOS 103 may refine the association or correlation of some or all of the determined information to the particular journey page that was generated, based on the received feedback (e.g., received at 120). For example, as described above, a predictive model may be modified according to the confidence level associated with feedback (e.g., low confidence feedback will modify a predictive model less than high confidence feedback, etc.).

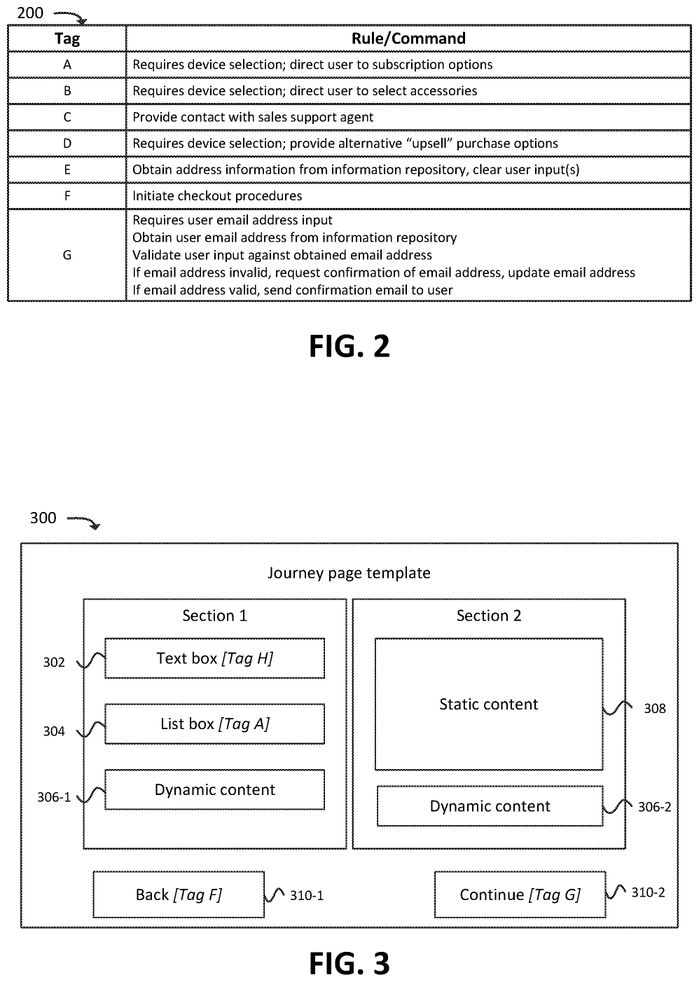

FIG. 2 illustrates an example data structure 200 that may be used by JOS 103 in some embodiments. For instance, example data structure 200 may conceptually represent information, maintained or received by JOS 103, which includes sets of actions and/or rules (referred to herein simply as a “set of actions”) relating to journey states, which may indicate one or more actions to perform based on received input, and/or a next journey state. In some embodiments, a set of actions may include, or may be associated with, constraints or requirements for received input. As described below, actions may be defined on a per-element basis, defined for a group of elements, or for a journey state or journey page.

For instance, a first tag (shown in the figure as “Tag A”) may be associated with a set of actions that indicate that, when user input is received in connection with Tag A, there is a required device selection and that the user should be directed to a particular page (e.g., a page container subscription options based on the selection of the UI element associated with Tag A). As further shown, another example tag (e.g., Tag C) may indicate that when user input is received in connection with Tag C, UE 101 may be put into contact with a sales support agent. For example, upon receiving an input associated with Tag C, JOS 103 may open a live text-based chatting box, schedule a telephonic call, and/or otherwise connect UE 101 with a sales support agent.

A set of actions may include conditional statements, such as an if-then construct. For instance, Tag G may be associated with a set of actions that indicate that, when user input is received in connection with Tag G, JOS 103 should obtain user email address from information repository (e.g., UI template repository 105). Additionally, the actions associated with Tag G may include validating the received user input against the email address obtained from the information repository. If the email address is invalid (e.g., as determined by the comparison or validation of the received user input against the email address obtained from the information repository), the actions associated with Tag G may indicate that correction should be requested (e.g., JOS 103 should communicate with UE 101 to indicate that the user input was invalid, and/or to request a corrected email address) and, upon receipt of a confirmed email, to update the email address in the information repository. On the other hand, if the email address is valid, the set of actions may indicate that JOS 103 should send a confirmation email to the user.

While data structure 200 is illustrated as a table, data structure 200 may, in practice, be arranged, stored, or organized in some other arrangement. For instance, data structure 200 may include an array, a linked list, a tree, a hash table, and/or some other data structure. Additionally, in some embodiments, data structure 200 may be arranged in a hierarchical manner. For instance, assuming that input is received with Tag A, JOS 103 may stop evaluating the input to determine whether any of the other conditions are met. In some embodiments, JOS 103 may continue evaluating the input even when other conditions are met. In some embodiments, individual tags may be associated with an “exit” (or similar command) which explicitly state that after the actions associated with the tag are executed, no more tags should be evaluated. In these embodiments, in the absence of such an “exit” command, JOS 103 may continue evaluating tags, even if one tag is satisfied. The information stored in data structure 200 may be received from, for example, a developer, designer, owner, operator, or the like, of a UI that is provided to UE 101, or of JOS 103.

FIG. 3 conceptually illustrates example GUI 300, which may be a graphical representation of an example template (e.g., as stored by UI template repository 105) that may be selected by JOS 103, as similarly described above. As shown, example GUI 300 may include graphical interactive elements, such as text box 302, list box 304, dynamic content fields 306-1 and 306-2, static content field 308, and buttons 310-1 and 310-2 (hereinafter sometimes referred to individually as “button 310” or collectively as “buttons 310”).

As shown, text box 302, list box 304, and buttons 310 may each be associated with one or more tags. When input is received via a particular graphical interactive element, the input may be provided to JOS 103, along with any associated tag(s). For instance, when text is received via text box 302, the device that is presenting GUI 300 (e.g., UE 101) may provide the received text and the associated tag (i.e., Tag G in this example) to JOS 103. In some embodiments, GUI 300 may be defined such that input received via one or more of the graphical interactive elements (e.g., text box 302 and/or list box 304) may require input via another graphical interactive element before sending the input and associated tag(s) to JOS 103. For instance, GUI 300 may be defined such that input received via text box is provided to JOS 103 after Continue Button 310-2 is selected. Additionally, or alternatively, GUI 300 may be defined such that input received via text box 302 is provided to JOS 103 independent of a selection of any of buttons 310. In some embodiments, the selection of one graphical interactive element may cause input received via some or all of the other graphical interactive elements of GUI 300 to be provided to JOS 103. For instance, selection of Continue Button 310-2 may cause any or all input, input via text box and/or list box 304, be provided to JOS 103 (e.g., with their respective tags).

GUI 300 may be a conceptual representation, in that the actual display of GUI 300 on UE 101 may be different. For instance, the tags may not be visibly presented in GUI 300 when UE 101 displays GUI 300. Further, different or additional text may be presented in GUI 300 when UE 101 displays GUI 300. In some embodiments, GUI 300 may be based on a template (e.g., received via UI template repository 105), in that the tags and/or functional relationships between different elements may be defined by one entity (e.g., one developer or development team), while the content of GUI 300 (e.g., text, images, and/or other content to be displayed) may be defined by another entity (e.g., dynamic content received from DIR 107). In this manner, GUI 300 may be dynamic and adaptable to different uses, without requiring the actual interactive elements or their relationships to be modified.

Further, while GUI 300 is discussed in the context of graphical interactive elements, other types of interactive elements may be used in addition to, or in lieu of, graphical interactive elements. For example, GUI 300 may include interactive elements that receive audio input (e.g., via a microphone of UE 101, image or video interactive elements (e.g., via a camera of UE 101), interactive elements that receive haptic input (e.g., via a touchscreen or touchpad of UE 101), interactive elements that receive input via a stylus of UE 101, and/or other types of interactive elements.

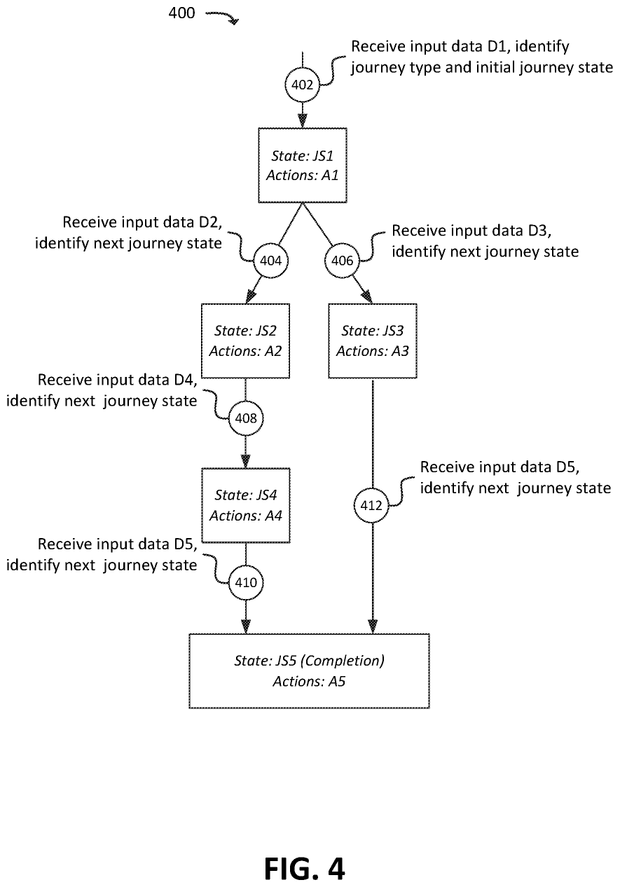

FIG. 4 illustrates an example journey flow, indicating various states through which a user associated with UE 101 may undergo. In some embodiments, these states may be provided as part of a Journey Service Protocol (“JSP”). For example, according to the JSP, JOS 103 may receive (at 402) a particular set of input data “D1” (e.g., via a GUI presented on UE 101), and may determine that the particular input data D1 is associated with a particular type of journey (e.g., may select a particular journey out of a set of candidate journeys, based on the input data and/or based on other factors). Additionally, or alternatively, JOS 103 may receive an explicit JSP request from UE 101, requesting a particular journey or journey type, where the request includes the data associated with initiating the journey. As part of selecting or identifying the journey, JOS 103 may also identify an initial journey state associated with the selected journey.

As shown, for example, journey 400 may start with initial journey state “JS1.” Further, JOS 103 may identify a set of rules and/or actions “A1” associated with JS1, and may perform some or all of the rules and/or actions, and/or may instruct UE 101 to perform some or all of the rules and/or actions. For example, as mentioned above, each journey state may be associated with a set of actions, such as the presentation of information at UE 101, the validation of input data, and/or other suitable actions. In some embodiments, when initiating the journey (e.g., selecting JS1), JOS 103 may assign a journey identifier to the journey, which may be used to uniquely identify the journey associated with the particular UE 101. In some embodiments, JOS 103 may provide this identifier to UE 101 (e.g., as part of the set of actions A1, and/or in conjunction with performing actions A1). In some embodiments, the set of actions may be provided in the form of action identifiers or tags (e.g., as similarly discussed above). Briefly, the action identifiers or tags may specify constraints, actions, rules, etc. associated with further requested user input, such as whether a particular input item is required, validation rules for user input associated with state JS1, data types of user input associated with state JS1, acceptable values for user input associated with state JS1, etc.

As shown, journey 400 may include two possible branches from JS1, depending on inputs received once JS1 has been reached (e.g., after the set of actions A1 have been performed). For example, based on receiving (at 404) one set of input data D2, JOS 103 may determine to progress from JS1 to JS2, while based on receiving (at 406) a second set of input data D3, JOS 103 may determine to progress from JS1 to JS3. In some embodiments, input data D2 and/or D3 may be accompanied by a journey identifier (e.g., as provided to UE 101). Additionally, or alternatively, JOS 103 may identify the particular journey based on receiving an identifier of UE 101 (e.g., an IP address, MIDN, etc.), and linking the identifier of UE 101 to the particular journey.

As further shown, if JOS 103 receives (at 408) a particular set of input data D4 from UE 101 after state JS2 has been reached, JOS 103 may determine that the next state is state JS4, which is associated with actions A4. Similarly, when receiving (at 410) a particular set of input data D5 from UE 101 after state J54 has been reached, JOS 103 may determine that the next state is JS5, with associated actions A5. Further, JS5 may be designated as a completion state. That is, user input received at state JS5 may be evaluated as part of a new journey, or may not be evaluated as part of a journey at all. As further shown, the same completion state JS5 may be reached (at 412) from state J53. For example, JOS 103 may receive (at 412) input data D5 while at state J53, leading to completion state JS5. That is, in some embodiments, the same input data (e.g., D5) may be received at different states (e.g., J53 or J54), which may lead to the same next state (e.g., JS5, in this example). In some embodiments, different input data from different states (e.g., input data D5 from JS4, and hypothetical input data D6 (not shown) from JS3) may lead to the same next state (e.g., JS5, in this example).

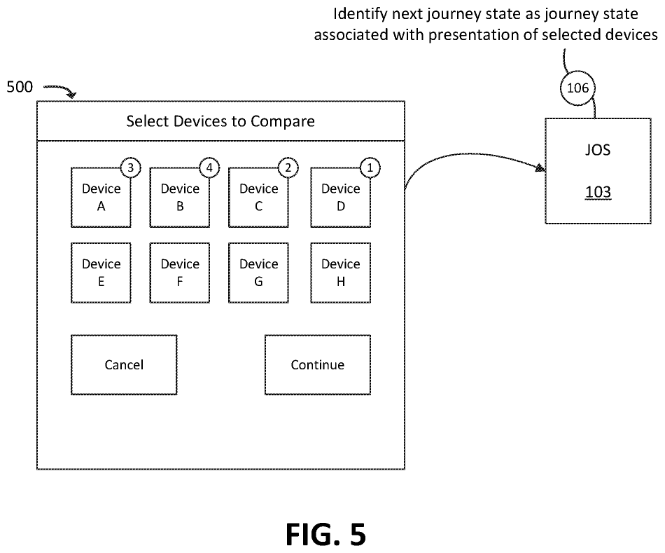

FIG. 5 conceptually illustrates the selection (e.g., at 106) of a template based on an input received via UE 101. For example, UI 500 may be a UI (e.g., associated with, or representing, a journey page) via which user input may be received, relating to the selection of multiple devices to compare. UE 101 may receive, for example, a selection of Devices A-D via UI 500. In this example, an order of preference may be indicated (e.g., as indicated by the “1” overlaid on Device D, the “2” overlaid on Device C, etc.). Further assume that rules associated with UI 500 (e.g., rules associated with a template based on which UI 500 was generated) indicate that selected graphical elements are associated with devices that are selected for comparison. Further assume that JOS 103 determines, based on the received input (e.g., the ordered selection of these devices, and/or rules indicating that devices selected via UI 500 should be compared) that the next journey state includes selecting a particular template associated with the selected devices, populating the particular template with the selected devices in order, and presenting the populated template page (e.g., the journey page for the next journey state) to UE 101 for comparison.

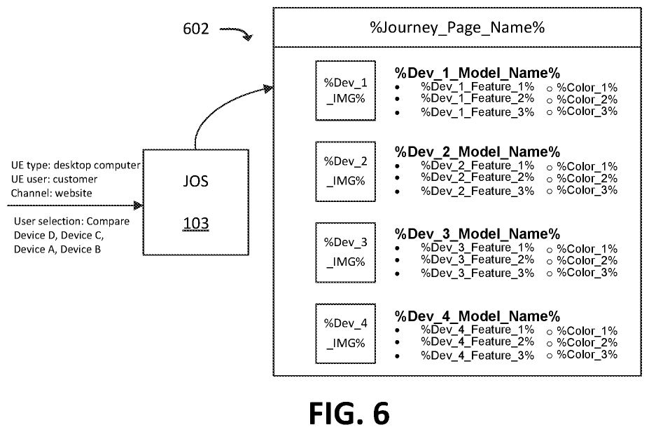

As shown in FIG. 6, JOS 103 may select example template 602 based on factors such as journey state, UE type, received input, user type, and/or other factors. For example, JOS 103 may receive information regarding UE 101 (e.g., information indicating that UE 101 is a desktop computer), a user associated with UE 101 (e.g., information indicating that the user is a “customer” type of user), and information regarding the journey state (e.g., compare selected devices). Further, JOS 103 may receive or determine the devices to be compared (i.e., the ordered selection of Devices A-D in UI 500).

As discussed herein, templates may be associated with particular journey states. In some embodiments, multiple different templates may be associated with the same particular journey state, but may be selected based on factors in addition to a determined journey state. In the example of FIG. 6, template 602 may represent an example template for a journey state related to the presentation of devices for purchase (e.g., based on the user inputs shown in FIG. 5). Further, template 602 may be associated with other factors, such as UE 101 having a relatively a high-resolution display or a relatively large display (e.g., a desktop computer), a determination that UE 101 is associated with a “website” type of channel, a determination that a user type is “customer,” and/or other factors.

As shown, template 602 may include fields for dynamic information, indicated by field codes (e.g., as shown, surrounded by “%” symbols) to be inserted by JOS 103. For example, at the top of template 602, JOS 103 may insert a page name in the field indicated by “%Journey_Page_Name%.” As further shown, fields in the template may distinguish information for each device. For example, field codes for features associated with a first device to be compared may be indicated by the prefix “Dev_1.” In other words, the prefix “Dev_1” is agnostic to how information is stored in DIR 107. For example, assume that template 602 is selected to compare Devices A-D. Based on received input, JOS 103 may assign Device D as the first device to be compared (e.g., “Dev_1”), Device C as the second device to be compared (e.g., “Dev_2”), Device A as the third device to be compared (e.g., “Dev_3”), and Device B as the fourth device to be compared (e.g., “Dev_4”). In such an instance, information for each device may be placed in fields corresponding to the order in which devices are to be compared. In other words, an image for Device C may be placed in the field indicated as “%Dev_2_IMG%,” a first feature for Device C may be placed in the field indicated as “% Dev_2_Feature_1%,” and so on.

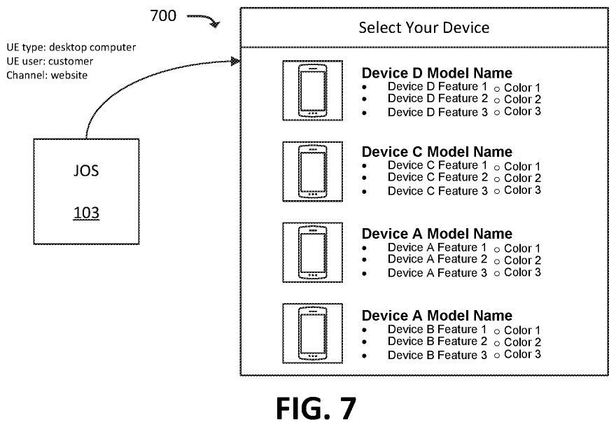

FIGS. 7-9 illustrate example journey pages that may be generated by JOS 103 based on selected templates. These journey pages may, for example, be associated with different templates selected for the same journey state (e.g., to compare different device models for the selection of a model for purchase), but may present different information or present information in a different fashion based on different channels, UE device type, and/or other factors. For example, FIG. 7 illustrates example journey page 700, based on template 602, in which a type of UE 101 is a “desktop computer,” the type of user is “customer,” and a channel type is “website.” As illustrated, the generated page may present multiple devices (Devices A-D) with a model name for each device, a picture associated with each device, features associated with each device, and colors in which each device is available. Further, journey page 700 may include a title of “Select Your Device.”

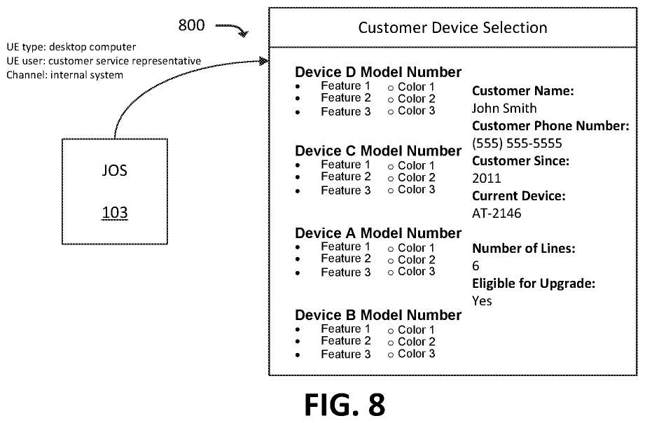

FIG. 8 illustrates example journey page 800, in which UE 101 is a “desktop computer” type of device, a channel is an “internal system” type of channel, and/or a user type is “customer service representative.” That is, journey page 800 may be based on a different template than template 602. While journey page 700 and journey page 800 may be associated with the same journey state, the templates may be different based on the differing UE capabilities or types (e.g., differing screen size or UE type), differing channels, etc.

As illustrated, journey page 800 may thus present similar information, and/or information derived from the same information, as presented via journey page 700. However, the presentation of information via journey page 800 may be different than the presentation of information via journey page 700. In some embodiments, some or all of the information presented via journey page 800 may be different than the information presented via journey page 700.

For example, journey page 800 may present model numbers (in lieu of model names) for each device, the features associated with each device, available colors for each device, and information regarding a customer, such as the customer name, customer phone number, the year the customer commenced service, whether the customer is eligible for an upgrade, the number of lines on the plan, and the current device associated with the customer. As further illustrated, journey page 800 may not present an image of each device and may include a journey page title of “Customer Device Selection” in lieu of “Select Your Device” as shown in journey page 700.

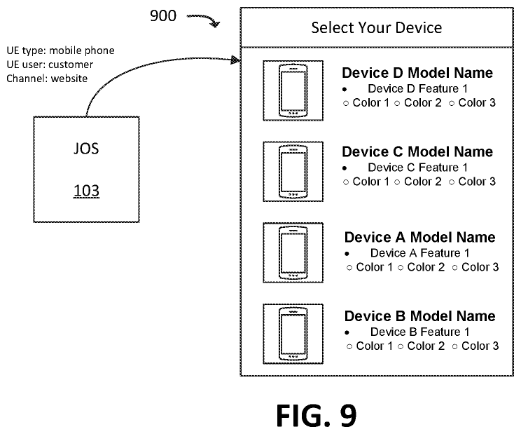

FIG. 9 illustrates example journey page 900 generated from a different template for the same journey state as above (e.g., the presentation of devices for selection for sale, as referred to in FIGS. 7 and 8). However, in this example, JOS 103 may select the template based on information regarding UE 101, which may have a device type of “mobile phone,” a user type of “customer,” and a channel type of “website.” In this example, information presented via journey page 900 may be presented differently, as compared to journey page 700. For example, as shown, journey page 900 may present model names for each device, an image for each device, and available colors for each device. However, the number of features may be truncated (i.e., here, instead of presenting three features for each device, only one feature may be presented). Further, the available colors may be presented horizontally, rather than vertically, to allow for a less wide presentation on UE 101 (e.g., as shown for journey pages 700 and 800, the color information may be presented adjacent to features, making a wider presentation).

While FIGS. 6-9 illustrate example journey pages, in practice, information may be presented in a different fashion than as presented in FIGS. 6-9, using one or more different techniques and/or styles. Similarly, in practice, generated journey pages may present more or less information than as shown in FIGS. 6-9. Further, as discussed above, journey pages may be presented audibly (e.g., via an IVR system) and/or in some other fashion.

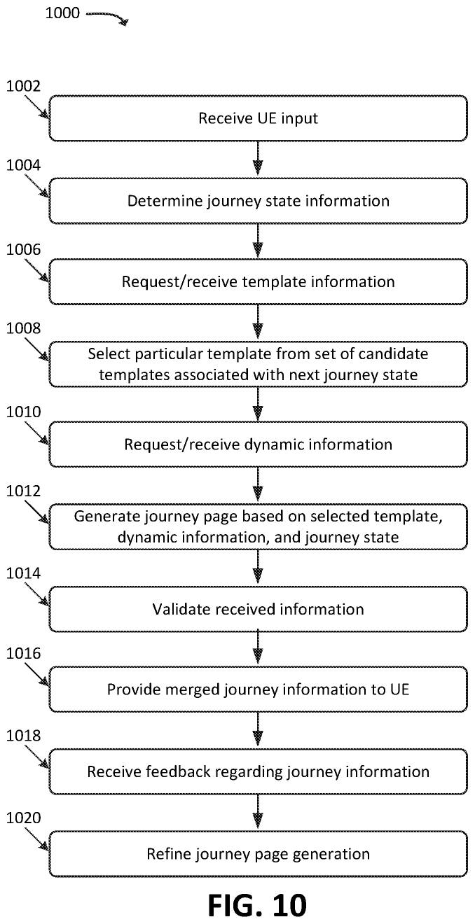

FIG. 10 illustrates an example process 1000 for generating a journey page for presentation to a user, based on a determined journey state. In some embodiments, some or all of process 1000 may be performed by JOS 103. In some embodiments, one or more other devices may perform some or all of process 1000 (e.g., in concert with, and/or in lieu of, JOS 103).

As shown, process 1000 may include receiving (at 1002) UE input. As described above, the input may correspond to user input received by UE 101. The input may include, or may be accompanied by, one or more tags, as described above. The input may include, for example, text, selections of UI elements, and/or other types of input. In some embodiments, the input may include, or may be accompanied by, metadata or other information, such as make and/or model of UE 101, location information associated with UE 101, a user profile or other type of user information associated with UE 101, etc.

Process 1000 may further include determining (at 1004) journey state information. For example, JOS 103 may determine a journey state (e.g., a next journey state) based on the content or type of user input (received at 1002), and/or other information (e.g., information regarding device type of UE 101, location information associated with UE 101, etc.).

Process 1000 may additionally include requesting and/or receiving (at 1006) template information for the determined next journey state. As discussed above, based on a particular journey state (e.g., determined at 1004), JOS 103 may obtain a set of templates from UI template repository 105. The templates may include interactive elements, dynamic information, static information, and/or other elements. In some embodiments, the templates may be received prior to, or independent of, the determination (at 1004) of a next journey state. For example, JOS 103 may maintain a set of templates prior to receiving (at 1002) input via UE 101.

Process 1000 may also include selecting (at 1008) a particular template, from a set of candidate templates. For example, JOS 103 may select a particular template from the set of templates (received at 1006). As described above, the template may be selected based on the next journey state, received input, information regarding capabilities or type of UE 101, a channel via which the user input was received (at 1002), one or more tags associated with the received input, and/or other factors described above.

Process 1000 may further include receiving (at 1010) dynamic information. Dynamic information may include information received via a repository such as information regarding UE 101 and/or a user associated with UE 101, and/or information regarding the journey state (e.g., determined at 1004). In some embodiments, the dynamic information may be set based on temporary and/or changing information (e.g., sales, specials, etc.).

Process 1000 may additionally include generating (at 1012) a journey page based on the selected template, received dynamic information, and journey state information. Generating a page may include combining the dynamic information (e.g., received at 1010) with the selected template (e.g., selected at 1008).

Process 1000 may also include validating (at 1014) the merged page. As described above, validating a page may include verifying whether all require inputs are provided, all fields associated with the template contain dynamic information, the determined next journey step is correct, and a correct template was selected.

Process 1000 may further include providing (at 1016) the generated page to a UE. JOS 103 may provide the generated page to UE 101 for display. In some embodiments, the page may be streamed to UE 101 (e.g., rendered on JOS 103 and/or another device for presentation on UE 101).

Process 1000 may additionally include receiving (at 1018) feedback regarding the generated page. As discussed above, feedback may be utilized to enhance the future generation of a page. For example, feedback may enhance the generation of a page via machine learning techniques, where user-reinforced feedback may be utilized to modify the generation of future journey pages.

Process 1000 may include refining (at 1020) one or more predictive models used to generate a journey page. For example, based on the feedback, JOS 103 may determine whether the selection (at 1008) of a particular template was accurate or otherwise appropriate for the selection information. JOS 103 may refine the association or correlation of some or all of the selection information to the particular template that was selected, based on the feedback (received at 1018).

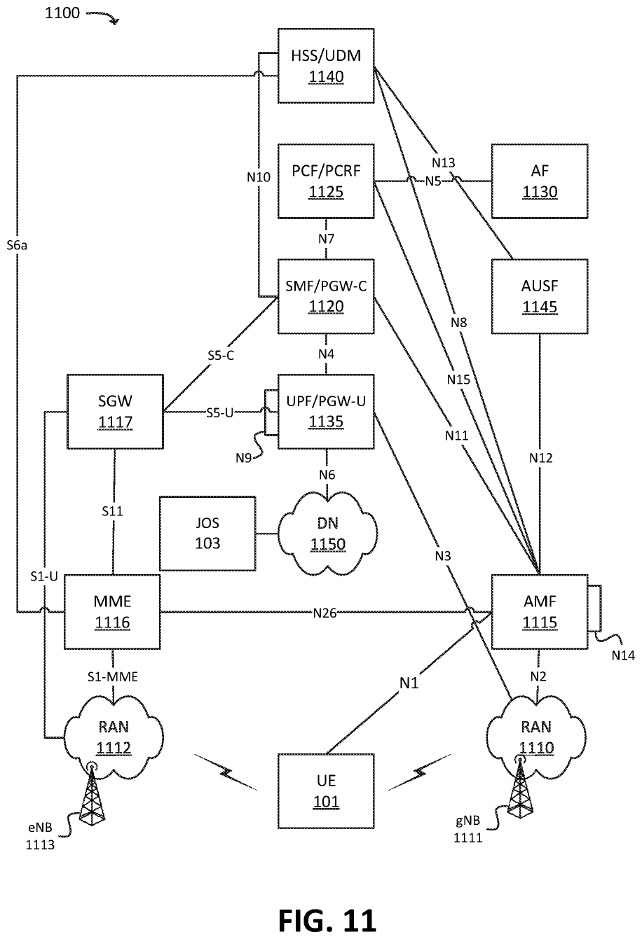

FIG. 11 illustrates an example environment 1100, in which one or more embodiments may be implemented. In some embodiments, environment 1100 may correspond to a Fifth Generation (“5G”) network, and/or may include elements of a 5G network. In some embodiments, environment 1100 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 1100 may include UE 101, radio access network (“RAN”) 1110 (which may include one or more Next Generation Node Bs (“gNBs”) 1111), RAN 1112 (which may include one or more one or more evolved Node Bs (“eNBs”) 1113), Access and Mobility Management Function (“AMF”) 1115, Mobility Management Entity (“MME”) 1116, Serving Gateway (“SGW”) 1117, Session Management Function (“SMF”)/Packet Data Network (“PDN”) Gateway (“PGW”)-Control plane function (“PGW-C”) 1120, Policy Control Function (“PCF”)/Policy Charging and Rules Function (“PCRF”) 1125, Application Function (“AF”) 1130, User Plane Function (“UPF”)/PGW-User plane function (“PGW-U”) 1135, HSS/UDM 1140, Authentication Server Function (“AUSF”) 1145, Data Network (“DN”) 1150, and JOS 103.

The quantity of devices and/or networks, illustrated in FIG. 11, is provided for explanatory purposes only. In practice, environment 1100 may include additional devices and/or networks, fewer devices and/or networks, different devices and/or networks, or differently arranged devices and/or networks than illustrated in FIG. 11. For example, while not shown, environment 1100 may include devices that facilitate or enable communication between various components shown in environment 1100, such as routers, modems, gateways, switches, hubs, etc. Alternatively, or additionally, one or more of the devices of environment 1100 may perform one or more functions described as being performed by another one or more of the devices of environment 1100. Devices of environment 1100 may interconnect with each other and/or other devices via wired connections, wireless connections, or a combination of wired and wireless connections. In some implementations, one or more devices of environment 1100 may be physically integrated in, and/or may be physically attached to, one or more other devices of environment 1100.

UE 101 may include a computation and communication device, such as a wireless mobile communication device that is capable of communicating with RAN 1110 and/or DN 1150. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, a Mobile-to-Mobile (“M2M”) device, or another type of mobile computation and communication device. UE 101 may send traffic to and/or receive traffic (e.g., user plane traffic) from DN 1150 via RAN 1110 and UPF/PGW-U 1135.

RAN 1110 may be, or may include, a 5G RAN that includes one or more base stations (e.g., one or more gNBs 1111), via which UE 101 may communicate with one or more other elements of environment 1100. UE 101 may communicate with RAN 1110 via an air interface (e.g., as provided by gNB 1111). For instance, RAN 1110 may receive traffic (e.g., voice call traffic, data traffic, messaging traffic, signaling traffic, etc.) from UE 101 via the air interface, and may communicate the traffic to UPF/PGW-U 1135, and/or one or more other devices or networks. Similarly, RAN 1110 may receive traffic intended for UE 101 (e.g., from UPF/PGW-U 1135, AMF 1115, and/or one or more other devices or networks) and may communicate the traffic to UE 101 via the air interface.

RAN 1112 may be, or may include, an LTE RAN that includes one or more base stations (e.g., one or more eNBs 1113), via which UE 101 may communicate with one or more other elements of environment 1100. UE 101 may communicate with RAN 1112 via an air interface (e.g., as provided by eNB 1113). For instance, RAN 1110 may receive traffic (e.g., voice call traffic, data traffic, messaging traffic, signaling traffic, etc.) from UE 101 via the air interface, and may communicate the traffic to UPF/PGW-U 1135, and/or one or more other devices or networks. Similarly, RAN 1110 may receive traffic intended for UE 101 (e.g., from UPF/PGW-U 1135, SGW 1117, and/or one or more other devices or networks) and may communicate the traffic to UE 101 via the air interface.

AMF 1115 may include one or more devices, systems, Virtualized Network Functions (“VNFs”), etc., that perform operations to register UE 101 with the 5G network, to establish bearer channels associated with a session with UE 101, to hand off UE 101 from the 5G network to another network, to hand off UE 101 from the other network to the 5G network, and/or to perform other operations. In some embodiments, the 5G network may include multiple AMFs 1115, which communicate with each other via the N14 interface (denoted in FIG. 11 by the line marked “N14” originating and terminating at AMF 1115).

MME 1116 may include one or more devices, systems, VNFs, etc., that perform operations to register UE 1101 with the EPC, to establish bearer channels associated with a session with UE 1101, to hand off UE 1101 from the EPC to another network, to hand off UE 1101 from another network to the EPC, manage mobility of UE 1101 between RANs 1112 and/or eNBs 1113, and/or to perform other operations.

SGW 1117 may include one or more devices, systems, VNFs, etc., that aggregate traffic received from one or more eNBs 1113 and send the aggregated traffic to an external network or device via UPF/PGW-U 1135. Additionally, SGW 1117 may aggregate traffic received from one or more UPF/PGW-Us 1135 and may send the aggregated traffic to one or more eNBs 1113. SGW 1117 may operate as an anchor for the user plane during inter-eNB handovers and as an anchor for mobility between different telecommunication networks or RANs (e.g., RANs 1110 and 1112).

SMF/PGW-C 1120 may include one or more devices, systems, VNFs, etc., that gather, process, store, and/or provide information in a manner described herein. SMF/PGW-C 1120 may, for example, facilitate in the establishment of communication sessions on behalf of UE 101. In some embodiments, the establishment of communications sessions may be performed in accordance with one or more policies provided by PCF/PCRF 1125.

PCF/PCRF 1125 may include one or more devices, systems, VNFs, etc., that aggregate information to and from the 5G network and/or other sources. PCF/PCRF 1125 may receive information regarding policies and/or subscriptions from one or more sources, such as subscriber databases and/or from one or more users (such as, for example, an administrator associated with PCF/PCRF 1125).

AF 1130 may include one or more devices, systems, VNFs, etc., that receive, store, and/or provide information that may be used in determining parameters (e.g., quality of service parameters, charging parameters, or the like) for certain applications.

UPF/PGW-U 1135 may include one or more devices, systems, VNFs, etc., that receive, store, and/or provide data (e.g., user plane data). For example, UPF/PGW-U 1135 may receive user plane data (e.g., voice call traffic, data traffic, etc.), destined for UE 101, from DN 1150, and may forward the user plane data toward UE 101 (e.g., via RAN 1110, SMF/PGW-C 1120, and/or one or more other devices). In some embodiments, multiple UPFs 1135 may be deployed (e.g., in different geographical locations), and the delivery of content to UE 101 may be coordinated via the N9 interface (e.g., as denoted in FIG. 11 by the line marked “N9” originating and terminating at UPF/PGW-U 1135). Similarly, UPF/PGW-U 1135 may receive traffic from UE 101 (e.g., via RAN 1110, SMF/PGW-C 1120, and/or one or more other devices), and may forward the traffic toward DN 1150. In some embodiments, UPF/PGW-U 1135 may communicate (e.g., via the N4 interface) with SMF/PGW-C 1120, regarding user plane data processed by UPF/PGW-U 1135.

HSS/UDM 1140 and AUSF 1145 may include one or more devices, systems, VNFs, etc., that manage, update, and/or store, in one or more memory devices associated with AUSF 1145 and/or HSS/UDM 1140, profile information associated with a subscriber. AUSF 1145 and/or HSS/UDM 1140 may perform authentication, authorization, and/or accounting operations associated with the subscriber and/or a communication session with UE 101.

DN 1150 may include one or more wired and/or wireless networks. For example, DN 1150 may include an IP-based PDN, a wide area network (“WAN”) such as the Internet, a private enterprise network, and/or one or more other networks. UE 101 may communicate, through DN 1150, with data servers, other UEs 1101, and/or to other servers or applications that are coupled to DN 1150. DN 1150 may be connected to one or more other networks, such as a public switched telephone network (“PSTN”), a public land mobile network (“PLMN”), and/or another network. DN 1150 may be connected to one or more devices, such as content providers, applications, web servers, and/or other devices, with which UE 101 may communicate.

JOS 103 may include one or more devices, systems, VNFs, etc., that provide for the generation of a journey page. As described above, JOS 103 may communicate with one or more devices to receive information to generate a journey page for display to UE 101. For example, while described above as receiving information regarding a user from an information repository, JOS 103 may receive information regarding a user or UE 101 from AUSF 1145 and/or HSS/UDM 1140 and/or some other suitable device or system.

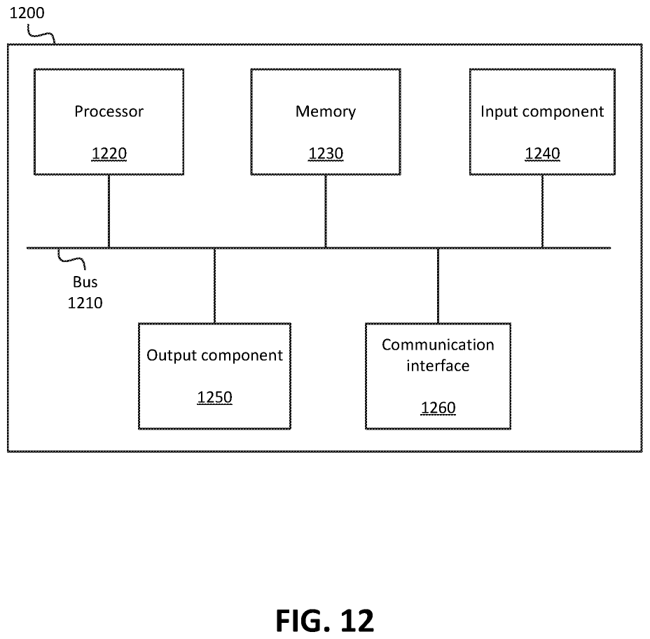

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, or processing logic that may interpret and execute instructions. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200, such as a keyboard, a keypad, a button, a switch, etc. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems. For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1200 may include more than one communication interface 1260. For instance, device 1200 may include an optical interface and an Ethernet interface.

Device 1200 may perform certain operations relating to one or more processes described above. Device 1200 may perform these operations in response to processor 1220 executing software instructions stored in a computer-readable medium, such as memory 1230. A computer-readable medium may be defined as a non-transitory memory device. A memory device may include space within a single physical memory device or spread across multiple physical memory devices. The software instructions may be read into memory 1230 from another computer-readable medium or from another device. The software instructions stored in memory 1230 may cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1 and 4-10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information provided by individuals, it should be understood that such information shall be collected, stored, and used in accordance with all applicable laws concerning protection of personal information. Additionally, the collection, storage, and use of such information may be subject to consent of the individual to such activity (for example, through “opt-in” or “opt-out” processes, as may be appropriate for the situation and type of information). Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive input from a user equipment (“UE”);
determine a type of channel via which the input was received from the UE, the type of channel being based on a mode of communication via which the input was received from the UE;
determine a particular journey state associated with the received input;
identify a plurality of templates associated with the determined particular journey state, wherein the plurality of templates include different templates that include different arrangements of data fields;
select a particular template, from the plurality of templates, based on the type of channel via which the input was received from the UE;
generate, based on the determined particular state and the selected template, a journey page, the generating including:
identifying a particular set of data fields associated with the selected template;
obtaining information based on the identified particular set of data fields; and
populating the particular set of data fields with the obtained information; and
provide, to the UE and in response to the input, the generated journey page.

2. The device of claim 1, wherein the type of channel includes a particular channel selected from a set of candidate channels, the set of candidate channels comprising:
a particular website,
a particular application, or
a particular Interactive Voice Response (“IVR”) system.

3. The device of claim 1, wherein the input is a first input, wherein the UE is a first UE, wherein the channel is a first channel, wherein the type of the first channel is a first type of channel, wherein the template is a first template, wherein the journey page is a first journey page, wherein the one or more processors are further configured to:
receive second input from a second UE, wherein the request includes information regarding the UE;
determine that a journey state associated with the received second input is a same journey state as the particular journey state associated with the first input;
determine a second type of channel via which the second input was received from the UE, the second channel being different from the first channel;
select a second template, from the plurality of templates, based on the journey state associated with the second input and further based on the second type of channel via which the second input was received from the UE, the second template being different from the first template;
generate a second journey page based on the selected second template, the second journey page being different from the first journey page; and
provide, to the second UE and in response to the second input, the generated second journey page.

4. The device of claim 3, wherein the second template includes different types of information associated than the first template.

5. The device of claim 3, wherein the second template includes a different arrangement of data fields than the first template.

6. The device of claim 1, wherein the one or more processors are further configured to:
identify one or more attributes associated with the UE, wherein selecting the particular template is further based on the identified attributes associated with the UE.

7. The device of claim 1, wherein the one or more processors are further configured to:
identify one or more attributes of a user associated with the UE, wherein selecting the particular template is further based on the identified attributes of the user associated with the UE.

8. A non-transitory computer-readable medium, storing a plurality of processor-executable instructions to:
determine a type of channel via which the input was received from the UE, the type of channel being based on a mode of communication via which the input was received from the UE;
determine a particular journey state associated with the received input;
identify a plurality of templates associated with the determined particular journey state, wherein the plurality of templates include different templates that include different arrangements of data fields;
select a particular template, from the plurality of templates, based on the type of channel via which the input was received from the UE;
generate, based on the determined particular state and the selected template, a journey page, the generating including:
identifying a particular set of data fields associated with the selected template;
obtaining information based on the identified particular set of data fields; and
populating the particular set of data fields with the obtained information; and
provide, to the UE and in response to the input, the generated journey page.

9. The non-transitory computer-readable medium of claim 8, wherein the type of channel includes a particular channel selected from a set of candidate channels, the set of candidate channels comprising:
a particular website,
a particular application, or
a particular Interactive Voice Response (“IVR”) system.

10. The non-transitory computer-readable medium of claim 8, wherein the input is a first input, wherein the UE is a first UE, wherein the channel is a first channel, wherein the type of the first channel is a first type of channel, wherein the template is a first template, wherein the journey page is a first journey page, wherein the plurality of processor-executable instructions further include processor-executable instructions to:
receive second input from a second UE, wherein the request includes information regarding the UE;
determine that a journey state associated with the received second input is a same journey state as the particular journey state associated with the first input;
determine a second type of channel via which the second input was received from the UE, the second channel being different from the first channel;
select a second template, from the plurality of templates, based on the journey state associated with the second input and further based on the second type of channel via which the second input was received from the UE, the second template being different from the first template;
generate a second journey page based on the selected second template, the second journey page being different from the first journey page; and
provide, to the second UE and in response to the second input, the generated second journey page.

11. The non-transitory computer-readable medium of claim 10, wherein the second template includes different types of information associated than the first template.

12. The non-transitory computer-readable medium of claim 10, wherein the second template includes a different arrangement of data fields than the first template.

13. The non-transitory computer-readable medium of claim 8, wherein the plurality of processor-executable instructions further include processor-executable instructions to:
identify one or more attributes associated with the UE, wherein selecting the particular template is further based on the identified attributes associated with the UE.

14. The non-transitory computer-readable medium of claim 8, wherein the plurality of processor-executable instructions further include processor-executable instructions to:
identify one or more attributes of a user associated with the UE, wherein selecting the particular template is further based on the identified attributes of the user associated with the UE.

15. A method, comprising:
determining a type of channel via which the input was received from the UE, the type of channel being based on a mode of communication via which the input was received from the UE;
determining a particular journey state associated with the received input;
identifying a plurality of templates associated with the determined particular journey state, wherein the plurality of templates include different templates that include different arrangements of data fields;
selecting a particular template, from the plurality of templates, based on the type of channel via which the input was received from the UE;
generating, based on the determined particular state and the selected template, a journey page, the generating including:
identifying a particular set of data fields associated with the selected template;
obtaining information based on the identified particular set of data fields; and
populating the particular set of data fields with the obtained information; and
providing, to the UE and in response to the input, the generated journey page.

16. The method of claim 15, wherein the type of channel includes a particular channel selected from a set of candidate channels, the set of candidate channels comprising:
a particular website,
a particular application, or
a particular Interactive Voice Response (“IVR”) system.

17. The method of claim 15, wherein the input is a first input, wherein the UE is a first UE, wherein the channel is a first channel, wherein the type of the first channel is a first type of channel, wherein the template is a first template, wherein the journey page is a first journey page, the method further comprising:
receiving second input from a second UE, wherein the request includes information regarding the UE;
determining that a journey state associated with the received second input is a same journey state as the particular journey state associated with the first input;
determining a second type of channel via which the second input was received from the UE, the second channel being different from the first channel;
selecting a second template, from the plurality of templates, based on the journey state associated with the second input and further based on the second type of channel via which the second input was received from the UE, the second template being different from the first template;
generating a second journey page based on the selected second template, the second journey page being different from the first journey page; and
providing, to the second UE and in response to the second input, the generated second journey page.

18. The method of claim 17, wherein the second template includes different types of information associated than the first template.

19. The method of claim 17, wherein the second template includes a different arrangement of data fields than the first template.

20. The method of claim 15, the method further comprising:
identifying one or more attributes associated with the UE, wherein selecting the particular template is further based on the identified attributes associated with the UE.
